(19) United States
(12) Patent Application Publication
(10) Pub. No.: US 2026/0252859 A1
(43) Pub. Date: Aug. 27, 2026

(54) SYSTEMS AND METHODS FOR INFERRING AND RESOLVING POTENTIAL ACCOUNT PROBLEMS

(71) Applicant: GOOGLE LLC, Mountain View, CA (US)

(72) Inventors: Kumar Mayank, Saratoga, CA (US); Andy McCraw, San Clemente, CA (US); Cory Sharp, San Francisco, CA (US); Azba Gurm, Eugene, OR (US); Nikita Goswami, Everett, WA (US); Sonal Sudhakar Bobde, Sunnyvale, CA (US); George Chearswat, Cupertino, CA (US); Sean Michael Astrup, Denver, CO (US)

(21) Appl. No.: 19/431,415

(22) Filed: Dec. 23, 2025

Related U.S. Application Data
(60) Provisional application No. 63/763,635, filed on Feb. 26, 2025.

(51) Int. Cl. G06N 3/0475; G06N 3/08

(52) U.S. Cl. CPC G06N 3/0475; G06N 3/08

(57) ABSTRACT

Systems and methods for generating personalized solution recommendations for a user problem. Such a method includes (i) receiving an error indication from a user associated with an account profile including user account data; (ii) retrieving, based on the error indication, an information resource of a plurality of information resources; (iii) inferring, based on the user account data, a problem associated with the information resource and the account profile; (iv) generating, using a trained machine learning model, an information resource summary for the information resource by using the information resource and the inferred problem as inputs to the trained machine learning model; (v) determining whether one or more metrics associated with the information resource summary meet one or more quality criteria; and (vi) training the trained machine learning model based on (a) whether the one or more metrics meet the one or more quality criteria and (b) the information resource summary.

### CROSS-REFERENCE TO RELATED APPLICATIONS

This application claims priority to and the benefit of the filing date of provisional U.S. Patent Application No. 63/673,635 entitled “SYSTEMS AND METHODS FOR INFERRING AND RESOLVING POTENTIAL ACCOUNT PROBLEMS,” filed on Feb. 26, 2025. The entire contents of the above application are hereby expressly incorporated herein by reference.

### FIELD OF TECHNOLOGY

The present disclosure relates to generating personalized summaries and solutions to a user and, more specifically, to techniques for inferring user account problems and generating solutions and summaries related to solutions for such, as well as detecting hallucinations and correcting such.

### BACKGROUND

The background description provided herein is for the purpose of generally presenting the context of the disclosure. Work of the presently named inventor(s), to the extent it is described in this background section, as well as aspects of the description that may not otherwise qualify as prior art at the time of filing, are neither expressly nor impliedly admitted as prior art against the present disclosure.

When a user is experiencing difficulties with an account (e.g., difficulties with using a platform or product associated with the user's account), the user must conventionally seek out a database, search through information resources, determine a matching problem and solution, and subsequently navigate through a platform or product associated with the account to implement the solution to the problem. However, when users are unfamiliar with the platform or product, or when a problem can be expressed in various different ways or is difficult to grasp, errors may occur and/or computing resources may be wasted.

### SUMMARY

In some aspects, the techniques described herein relate to a computer-implemented method for generating personalized solution recommendations for a user problem, the computer-implemented method including: receiving, by one or more processors, an error indication from a user associated with an account profile, the account profile including user account data; retrieving, by the one or more processors and based on the error indication, an information resource of a plurality of information resources; inferring, by the one or more processors and based on the user account data, a problem associated with the information resource and the account profile; generating, by the one or more processors and using a trained machine learning model, an information resource summary for the information resource of the plurality of information resources by using the information resource and the inferred problem as inputs to the trained machine learning model; determining, by the one or more processors, whether one or more metrics associated with the information resource summary meet one or more quality criteria; and training, by the one or more processors, the trained machine learning model based on (i) whether the one or more metrics meet the one or more quality criteria and (ii) the information resource summary.

In some aspects, the techniques described herein relate to a computer-implemented method, further including: displaying, by the one or more processors, the information resource summary to the user in an online real-time environment.

In some aspects, the techniques described herein relate to a computer-implemented method, wherein (i) the determining whether the one or more metrics meet the one or more quality criteria and (ii) the training occur in an offline virtual testing environment.

In some aspects, the techniques described herein relate to a computer-implemented method, wherein inferring the problem includes: determining, by the one or more processors, relevancy scores for a plurality of inferred problems, the plurality of inferred problems including the inferred problem; and determining, by the one or more processors, a most likely problem for the user based on the relevancy scores for the plurality of inferred problems.

In some aspects, the techniques described herein relate to a computer-implemented method, further including: determining, by the one or more processors, whether a status of the account profile includes a first status indicator or a second status indicator; wherein (i) the generating of the information resource summary, (ii) the determining of whether the one or more metrics meet the one or more quality criteria, and (iii) the training of the trained machine learning model occur responsive to determining that the status of the account profile includes the first status indicator.

In some aspects, the techniques described herein relate to a computer-implemented method, further including: responsive to determining that the status of the account profile includes the second status indicator: generating, by the one or more processors, a proposed solution response to the inferred problem, and responsive to receiving an indication from the user, implementing the proposed solution response to the inferred problem.

In some aspects, the techniques described herein relate to a computer-implemented method, wherein the trained machine learning model is a first trained machine learning model and the information resource summary includes an element that, when interacted with, initiates a second trained machine learning model, the method further including: detecting, by the one or more processors, an interaction event with the element; responsive to the detecting, automatically inputting at least the inferred problem and the information resource summary into the second trained machine learning model; and generating, by the one or more processors and using the second trained machine learning model, a recommended solution response to the inferred problem.

In some aspects, the techniques described herein relate to a computer-implemented method, wherein the recommended solution response to the inferred problem includes a product link that, when interacted with by the user, automatically implements at least part of the recommended solution response.

In some aspects, the techniques described herein relate to a computer-implemented method, wherein the product link includes a deeplink to a particular portion of a product associated with the product link.

In some aspects, the techniques described herein relate to a computer-implemented method, wherein the one or more metrics include at least one of: (i) actuality, (ii) presence of particular generated components (iii) topic relevance, (iv) information resource relation, (v) user behavior expectations, or (vi) presence of solution.

In some aspects, the techniques described herein relate to a computing system configured to generate personalized solution recommendations for a user problem, the computing system including: one or more processors; and a memory storing instructions that, when executed, cause the one or more processors to: receive an error indication from a user associated with an account profile, the account profile including user account data; retrieve, based on the error indication, an information resource of a plurality of information resources; inferring, based on the user account data, a problem associated with the information resource and the account profile; generate, using a trained machine learning model, an information resource summary for the information resource of the plurality of information resources by using the information resource and the inferred problem as inputs to the trained machine learning model; determine whether one or more metrics associated with the information resource summary meet one or more quality criteria; and train the trained machine learning model based on (i) whether the one or more metrics meet the one or more quality criteria and (ii) the information resource summary.

In some aspects, the techniques described herein relate to a computing system, wherein the memory stores further instructions that, when executed, cause the one or more processors to: display the information resource summary to the user in an online real-time environment.

In some aspects, the techniques described herein relate to a computing system, wherein (i) determining whether the one or more metrics meet the one or more quality criteria and (ii) training the trained machine learning model occur in an offline virtual testing environment.

In some aspects, the techniques described herein relate to a computing system, wherein inferring the problem includes: determining relevancy scores for a plurality of inferred problems, the plurality of inferred problems including the inferred problem; and determining a most likely problem for the user based on the relevancy scores for the plurality of inferred problems.

In some aspects, the techniques described herein relate to a computing system, wherein the memory stores further instructions that, when executed, cause the one or more processors to: determine whether a status of the account profile includes a first status indicator or a second status indicator; wherein (i) generating the information resource summary, (ii) determining whether the one or more metrics meet the one or more quality criteria, and (iii) training the trained machine learning model occur responsive to determining that the status of the account profile includes the first status indicator.

In some aspects, the techniques described herein relate to a computing system, wherein the memory stores further instructions that, when executed, cause the one or more processors to: responsive to determining that the status of the account profile includes the second status indicator: generate a proposed solution response to the inferred problem, and responsive to receiving an indication from the user, implement the proposed solution response to the inferred problem.

In some aspects, the techniques described herein relate to a computing system, wherein the trained machine learning model is a first trained machine learning model, the information resource summary includes an element that, when interacted with, initiates a second trained machine learning model, and the memory stores further instructions that, when executed, cause the one or more processors to: detect an interaction event with the element; responsive to detecting the interaction event, automatically input at least the inferred problem and the information resource summary into the second trained machine learning model; and generate, using the second trained machine learning model, a recommended solution response to the inferred problem.

In some aspects, the techniques described herein relate to a computing system, wherein the recommended solution response to the inferred problem includes a product link that, when interacted with by the user, automatically implements at least part of the recommended solution response.

In some aspects, the techniques described herein relate to a computing system, wherein the product link includes a deeplink to a particular portion of a product associated with the product link.

In some aspects, the techniques described herein relate to a computing system, wherein the one or more metrics include at least one of: (i) actuality, (ii) presence of particular generated components (iii) topic relevance, (iv) information resource relation, (v) user behavior expectations, or (vi) presence of solution.

### BRIEF DESCRIPTION OF THE DRAWINGS

FIG. 1 is a block diagram of an example system in which techniques of the present disclosure can be implemented.

FIG. 2A depicts an example artificial intelligence model that may be implemented in the system of FIG. 1.

FIG. 2B depicts an example large language model that may be implemented in the system of FIG. 1.

FIG. 3 depicts an example user interface (UI) for generating personalized solution recommendations for an inferred user problem and presenting an associated information resource to the user, implemented in the system of FIG. 1.

FIGS. 4A-4C depict exemplary solution summaries that are generated to prompt a user to implement and/or allow the system to implement a determined solution, implemented in the system of FIG. 1.

FIG. 5 is a flow diagram of an example method for generating personalized solution recommendations for a user problem, implemented in the system of FIG. 1.

### DETAILED DESCRIPTION OF THE DRAWINGS

By using large language models (LLMs), the instant techniques enable automatic searching of relevant information resources, as well as generation of a summary that the user can more easily review and utilize. However, traditional LLMs are unable to perform the tasks required in a satisfactory manner. In particular, traditional LLMs (i) are often unable to parse through an information resource to accurately determine what problem a user may be having; (ii) tend to at best direct and instruct a user how to proceed in a broad manner to address a specific error they may indicate, which can lead to errors due to lack of specificity, ambiguity, etc.; and (iii) are prone to hallucinations, which lead to incorrect information being given to a user and potentially additional and/or more impactful errors. In other words, trying to directly provide a summary to address an error may be counter-productive and consequently an inefficient use of LLMs. To address such shortcomings, additional techniques are described herein.

In particular, an LLM of the present disclosure may be trained on, analyze, and/or receive an output from another model or algorithm regarding specific user account data to infer/detect a problem the user is having. By utilizing account-specific data, the LLM can receive and utilize context and/or other particular user details to accurately infer what problem a user is having and/or predict what details a user would be interested in regarding a particular information resource, notably to address the identified problem. This in turn enables the LLM to provide more specific and more useful information (directions, instructions, etc.) to the user.

Further, the LLM may be trained to determine a particular platform or product to which the user may navigate and/or utilize to solve a problem, and/or a particular portion of the platform or product in question. As such, the instant techniques may include training the LLM to determine, generate, and/or otherwise obtain links to a particular portion, function, menu, page, etc., in the platform or product (referred to herein as a “product deeplink”). The LLM may then embed the product deeplink in the generated information resource summary and/or in a presented solution to the inferred solution (e.g., via a chat window, chatbot text exchange window, etc.). As such, the user may be directed and taken to a particular portion of an application or other such product rather than having to read, parse, and follow particular instructions.

Moreover, the LLM may be trained such that the output of the LLM adheres to one or more quality criteria, to enable detection and/or correction of hallucinations. In particular, the instant techniques may include utilizing the LLM to generate an output and saving the conditions, parameters, and/or output via an offline, virtual testing environment for later testing and modification. The instant systems may analyze the output of the LLM to determine whether one or more quality criteria for the output based on one or more metrics are met and, if not, may modify and/or retrain the LLM. The instant systems may then utilize the offline virtual testing environment to test the updated and/or modified LLM and ensure that hallucinations are not being generated and/or that accurate, useful information is being generated by the LLM. The proposed solution, therefore, can rely upon the determination of a specific problem to improve the identification of a solution, provided via the summary. Indeed, a same error and/or error indication reported by a user can be shared in several different situations depending on, for example, the granularity of an error identification, thereby introducing uncertainties of what the error may correspond to. By relying solely on an error without considering user specifics, the summary of a relevant information resource may hallucinate due to the uncertainty surrounding the error. The proposed solution advantageously introduces a user specific problem associated with the error (i.e., a problem based on the user profile), to fine-tune how the LLM can summarize the information resource. The problem may be inferred from the user account, as a problem related to an error may be user account specific depending on a level of subscription, available account options, history of usage, or type of products that could cause display errors. Indeed, the inferred problem can be seen as an intermediary input, generated based on the user profile as described further herein, that helps disambiguate to what the error may correspond. In other words, by generating a summary of the information resource based on this intermediary input, the present system can provide a more robust solution (e.g., by eliminating hallucinations) to generate an information resource summary using a trained machine learning model. The model can itself be trained using feedback loop based quality metrics to assess the accuracy and/or quality of the proposed summary.

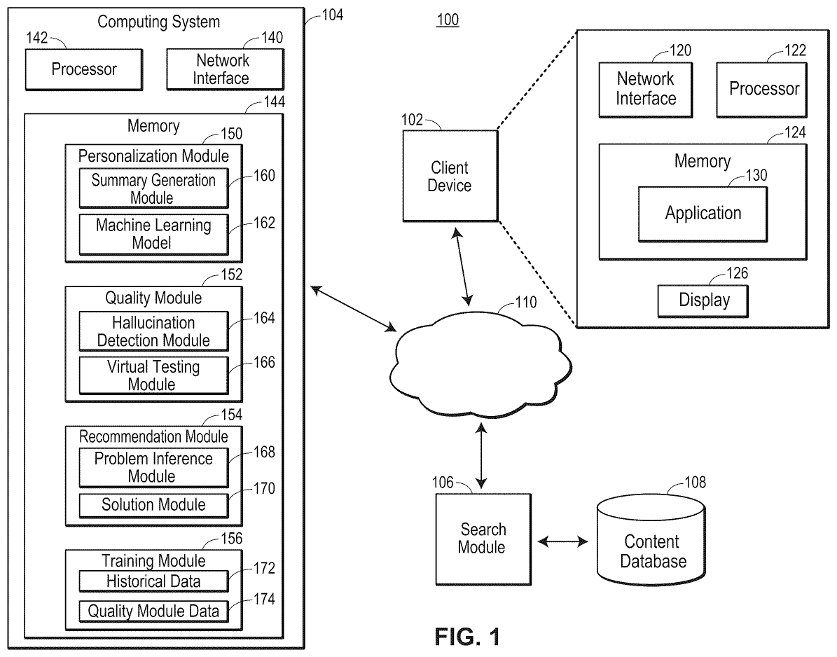

FIG. 1 illustrates an example system 100 in which the techniques disclosed herein may be implemented. The example system 100 includes a client device 102, a computing system 104, a search module 106, a content database 108, and a network 110. The computing system 104 in some implementations is remote from the client device 102 and/or search module 106, and communicatively coupled to the client device 102 and/or search module 106 via the network 110. It will be understood that system 100 is exemplary, and that other systems may include additional, fewer, or alternative components (e.g., training module 156 may be omitted, personalization module 150 and quality module 152 may be combined, etc.). Similarly, arrangements of the components of system 100 may be modified. For example, some elements of system 100 may be combined, split apart, swapped, etc.

The network 110 may be a single communication network (e.g., the Internet), and in some implementations also includes one or more additional networks. As an example, the network 110 may include a cellular network, the Internet, and a server-side local area network (LAN). While FIG. 1 shows only a single client device 102, computing system 104, and search module 106, it will be understood that the system 100 may include any suitable number of similar client devices, computing devices, and/or databases operating according to the principles disclosed herein.

Generally, the client device 102 is configured to access information resources (e.g., web pages, application user interfaces, etc.) that may be supplied or published by the computing system 104, content providers (e.g., storing content in content database 108), and/or other entities, and the computing system 104 is generally configured to analyze and select content to be served to the client device 102 along with links to information resources (e.g., landing pages). The information resources, and/or content items (e.g., digital advertisements) associated with the information resources, may be stored in content databases such as content database 108, and may be accessed by the client device 102 and/or computing system 104 through a search module 106 (e.g., a device including a search engine model and/or module). In other implementations, the search module 106 and/or content database 108 is instead a part of the computing system 104.

The client device 102 may be or include any stationary, mobile, or portable computing device with wired and/or wireless communication capability (e.g., a smartphone, a tablet computer, a laptop computer, a desktop computer, a smart wearable device such as smart glasses or a smart watch, a vehicle head unit computer, etc.). In the example implementation of FIG. 1, the client device 102 includes a network interface 120, a processor 122, memory 124, and a display 126. The processor 122 may be a single processor (e.g., a central processing unit (CPU)), or may include a set of processors (e.g., multiple CPUs, or one or more CPUs and one or more graphics processing units (GPUs)).

The memory 124 includes one or more computer-readable, non-transitory storage units or devices, which may include persistent (e.g., hard disk) and/or non-persistent memory components. The memory 124 stores instructions that are executable by the processor 122 to perform various operations, including the instructions of various software applications and the data generated and/or used by such applications. In the example implementation of FIG. 1, the memory 124 stores at least an application 130, which may be, for example, a web browser application, a mobile application downloaded from an application store, or a video player application.

Generally, application 130 is executed by processor 122 to present information resources, text data, image data, audio data, etc. to the user of the client device 102 via the display 126 (and/or one or more speakers of the client device 102, not shown in FIG. 1). In an implementation where the application 130 is a web browser application, for instance, an information resource may be a web page hosted by a publisher or a content provider, with the web browser causing the client device 102 to download HyperText Markup Language (HTML), scripts, and/or other code of the web page for presentation to a user via the display 126.

The display 126 includes hardware, firmware, and/or software configured to enable a user to view visual outputs of the client device 102, and may use any suitable display technology (e.g., LED, OLED, LCD, etc.). In some implementations, the display 126 is incorporated in a touchscreen having both display and manual input capabilities. Moreover, in some implementations where the client device 102 is a wearable device, the display 126 is a transparent viewing component (e.g., lenses of smart glasses) with integrated electronic components. For example, the display 126 may include micro-LED or OLED electronics embedded in lenses of smart glasses.

The network interface 120 includes hardware, firmware, and/or software configured to enable the client device 102 to exchange electronic data with the computing system 104 via the network 110. For example, the network interface 120 may include a cellular communication transceiver, a Wi-Fi transceiver, and/or transceivers for one or more other wired and/or wireless communication technologies.

While FIG. 1 shows client device 102 as a single component communicating directly (i.e., via network 110) with the computing system 104, in some implementations the subcomponents of client device 102 shown in FIG. 1 are instead divided among two or more user-side devices. As just one example, a pair of smart glasses may include the processor 122, the memory 124, and the display 126, while a smartphone may include another processing unit, another memory, another display, and the network interface 120. The smart glasses (or smart helmet, etc.) may then communicate as needed with the smartphone (e.g., via Bluetooth) to enable the operations described herein.

The computing system 104 includes a network interface 140, a processor 142, and memory 144. The network interface 140 includes hardware, firmware, and/or software configured to enable the computing system 104 to exchange electronic data with the client device 102 and other, similar client devices via the network 110. For example, the network interface 140 may include a wired or wireless router and a modem. The processor 142 may be a single processor, may include two or more processors, etc. The computing system 104 may include one or more servers, for example, which may reside at a single location or multiple locations.

The memory 144 is a computer-readable, non-transitory storage unit or device, or collection of units/devices that may include persistent and/or non-persistent memory components. The memory 144 stores the instructions of a personalization module 150, a quality module 152, a recommendation module 154, and a training module 156, each of which may be executed by the processor 142. In the example system 100, the personalization module 150 includes (or remotely accesses) a summary generation module 160 and/or a machine learning model 162. The quality module 152 includes (or remotely accesses) a hallucination detection module 164 and/or a virtual testing module 166. The recommendation module 154 includes (or remotely accesses) a problem inference module 168 and/or an solution module 170. The training module 156 uses historical data 172 and/or quality module data 174 to train one or more machine learning models (e.g., the summary generation module 160, hallucination detection module 164, virtual testing module 166, etc.). In some implementations, some of the software modules/units shown in FIG. 1 are omitted. For example, the recommendation module 154 may omit the solution module 170, or the computing system 104 may omit training module 156 (e.g., if the training is done by a different computing system). The personalization module 150, quality module 152, and/or recommendation module 154 may be or include an LLM or another suitable generative AI model. As another example, the personalization module 150 and recommendation module 154 include an LLM while the quality module 152 includes a non-LLM model.

The personalization module 150, quality module 152, recommendation module 154, and/or training module 156 may be software modules comprising instructions executed by the processor 142 to perform the various operations described herein. It is understood, however, that other architectures are also possible (e.g., with functionality of modules 150, 152, 154, and/or 156 being provided by a single software module, or with functionality of personalization module 150 being split among a plurality of software modules, and so on).

Generally, the personalization module 150 uses a summary generation module 160 and/or a machine learning model 162 to analyze information resources and/or content items stored in the content database 108 and/or accessed via a search module 106. In some implementations, a user provides an error indication (e.g., a search query) to the client device 102, which transmits the error indication to the computing system 104 via the network 110. The personalization module 150 may then access one or more information resources associated with content (e.g., products, documents, services, etc.). Using the summary generation module 160, the personalization module 150 may analyze the information resource and/or content item to generate an information resource summary. Depending on the implementation, the summary generation module 160 may analyze user account data and the information resource to determine relevance of various portions of the information resource to the user (e.g., by calculating relevancy scores for various sections of the information resource). For example, the summary generation module 160 may detect various segments and/or topics of an information resource. Depending on the implementation, the information resource may be labeled for analysis by the summary generation module 160 (e.g., headers may function as labels, metadata tags may function as labels, a human reviewer may label various portions of the information resource, etc.). In other implementations, the summary generation module 160 may be trained to distinguish and/or determine different sections without labels (e.g., detecting various keywords that historical training data would suggest is indicative of a particular section or topic, using OCR techniques to detect segment or line breaks, etc.). The summary generation module 160 may then generate a summary of the information resource as described in more detail below.

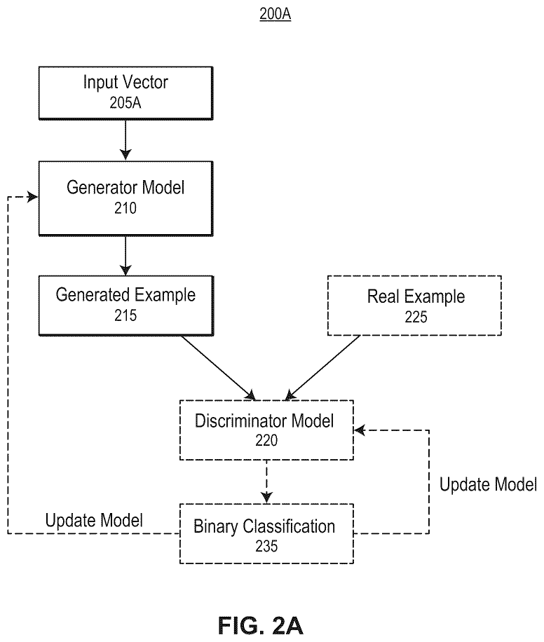

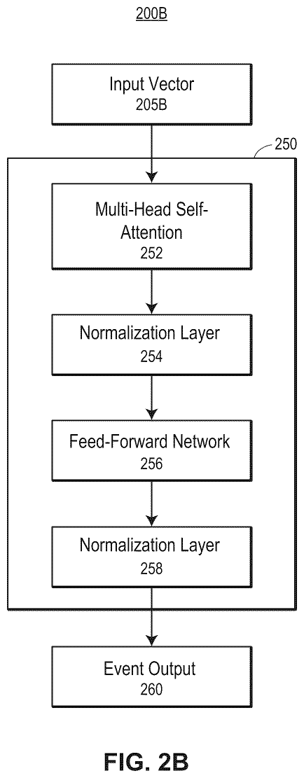

In some implementations, the summary generation module 160 is, includes, calls, or functions using machine learning model 162, which may be or behave similarly to an LLM as described below with regard to FIGS. 2A and 2B. In particular, the machine learning model 162 may be trained to determine relevancy scores of portions of the information resource compared to user account data. For example, the machine learning model 162 may determine the relevancy scores by determining a semantic similarity to one or more user account data status conditions, content items, enable settings, etc. and subsequently taking an average of the semantic similarities for a particular section. In further examples, the machine learning model 162 may additionally or alternatively determine a relevancy by detecting an error with the user account and/or content items uploaded via the user account and determine a relevancy score of sections of the information resource by determining a number of users with similar problems who viewed the page previously and/or indicated the page as including a solution.

In some implementations, the summary generation module 160 may analyze information resources, content items, and/or user account data including structured data sets, unstructured data sets, and/or combinations thereof. Similarly, the summary generation module 160 and/or machine learning model 162 may be or include multimodal models. For example, the summary generation module 160 may analyze an information resource with structured text data and unstructured video data. As such, the summary generation module 160 may analyze the information resource and treat structured and unstructured data separately. For example, the summary generation module 160 may perform semantic analysis on text data directly, but may instead call another model (e.g., machine learning model 162 and/or another model) separately to analyze the unstructured data (e.g., via OCR techniques, vision analysis, image segmentation techniques, convolutional neural networks (CNNs) and/or other neural networks configured to analyze images, etc.) to determine relevant textual descriptions of the unstructured data and then performing semantic analysis on the textual description(s).

The summary generation module 160 may then generate a summary of the information resource based on the user account data and/or relevancy scores of the information resource sections compared to the user account data. In some implementations, the summary generation module 160 may choose a predetermined number of sections with a greatest relevancy score and summarize the predetermined number of section s(e.g., using the machine learning model 162). In further implementations, the summary generation module 160 may summarize any section with a relevancy score that meets a predetermined threshold. In still further implementations, the summary generation module 160 summarizes the entirety of the information resource regardless of and/or without calculating relevancy scores. Similarly, the personalization module 150 may additionally use any other techniques as described herein for analyzing some or all of the information resource(s) and generating a summary of the information resource(s).

In some implementations, the quality module 152 uses a hallucination detection module 164 to detect and remediate errors in the summary generated by the personalization module 150. Depending on the implementation, the quality module 152 may perform the hallucination detection in real time or may do so in a virtual testing environment via a virtual testing module 166. As such, the quality module 152 may analyze the information resource summary in real time or may save the information resource summary and/or the inputs that caused the personalization module 150 to generate the information resource summary for later analysis in an offline environment to which the user associated with the account profile does not have access.

In some such implementations, the hallucination detection module 164 analyzes the information summary based on one or more metrics associated with the information resource and whether the one or more parameters/metrics meet one or more associated quality criteria. Depending on the implementation, the one or more metrics may include at least one of: (i) actuality (e.g., actual output values compared to predicted output values), (ii) presence of particular generated components (iii) topic relevance, (iv) information resource relation, (v) user behavior expectations, (vi) presence of solution, and/or (vii) any other such metric as described herein. If one or more metrics does not meet a corresponding quality criterion, the hallucination detection module 164 may determine that a hallucination is present in the information summary. The quality module 152 may then generate a corrected version of the information resource summary and/or flag the information resource summary and/or associated inputs for later analysis by the virtual testing module 166.

Depending on the implementation, the quality criteria may be or include a minimum quality bar (e.g., a minimum quality score allowed). In some such implementations, the minimum quality bars may be or include a different minimum quality bar for each metric. In some implementations, the quality criteria may be predetermined, adjustable, manually set, automatically generated, etc.

In some implementations, the virtual testing module 166 and/or hallucination detection module 164 automatically assesses (grades, scores, etc.) each parameter according to a rubric (e.g., 1-5, 1-10, 0-100, etc.). Depending on the implementation, the computing system 104 may initially train the machine learning model using manually labeled datasets graded according to the rubric (e.g., via the training module 156). In further implementations, the computing system 104 trains the machine learning model using datasets automatically generated by another machine learning model according to the rubric. In some such implementations, the machine learning model(s) evaluate each parameter using a separately generated set of prompts to determine an output score for each respective parameter. As such, the machine learning model(s) may produce scores both in aggregate (e.g., for all parameters) and/or for individual parameters.

The virtual testing module 166 may then make adjustments to the machine learning model 162 (e.g., in conjunction with and/or in place of the training module 156), adjust one or more prompts generated for use in generating the information resource summary, adjust weights of parameters, etc. In further implementations, the virtual testing module 166 may generate alternate scenarios (e.g., automatically using historical data, responsive to manual input from an administrator, etc.) and analyze the alternate scenarios (e.g., using alternate user data, using alternate search terms, using alternate information resources) to generate an alternate information summary. The virtual testing module 166 may similarly analyze and/or grade the alternate model (e.g., using the hallucination detection module 164) and, if one or more scenarios and/or an aggregated score for the model is better (e.g., higher than) those of the original model, replace the machine learning model 162 and/or corresponding values.

In some implementations, the virtual testing module 166 may be stored at a single computing device and/or system (e.g., computing system 104). Similarly, in further implementations, the virtual testing module 166 may be stored at multiple computing devices within one or more systems (e.g., one or more servers, such as an ad exchange server and possibly other servers). Depending on the implementation, the one or more computing devices and/or systems may be co-located with and/or remotely located from the computing system 104 and/or each other.

In some implementations, the virtual testing module 106 may include one or more copies of various software components, algorithms, models, modules, etc. stored at the computing system 104 for performing real time calculations and/or processes. However, in such implementations, operation of the virtual testing module 166 does not result in content items being provided/sent to any users/client devices such as client device 102. For example, the virtual testing module 166 may cause one or more outputs to be displayed on a device other than the client device 102 (e.g., for testing personnel to review) and/or stored at the computing system 104 and/or virtual testing module 166 for later review.

In some implementations, the virtual testing module 166 and other modules of the computing system 104 are isolated from each other. In particular, operation of the virtual test environment as implemented by virtual testing module 166 may not directly affect the configurations of any the machine learning model 162 and/or other such models unless changes are explicitly approved. In further implementations, the real time environment described herein for modules 150 and 154 and/or the virtual test environment described herein for virtual testing module 166 are implemented entirely, or in part, by computing system 104.

Advantageously, by using and updating a machine learning model as described above (e.g. machine learning model 162) and disclosed herein, the instant techniques lead to an improvement over traditional techniques. In particular, by testing the generated information resource summaries in a virtual test environment that is isolated from the production environment, poorly performing variants can be ignored or discarded without risk to the real-world performance of the model, while the model can be adjusted accordingly. Thus, the machine learning model is improved while reducing the risk of unintentional hallucination or other errors in summary generation.

The recommendation module 154 may infer one or more problems in the user account via the problem inference module 168 and may generate one or more solutions via the solution module 170. In some implementations, the recommendation module 154 determines the one or more problems based on one or more errors having occurred in the user account. For example, if the user has one or more content item campaigns that do not meet one or more guidelines and cannot be or are not displayed, the problem inference module 168 may determine that the user account has a content campaign problem. In further implementations, the problem inference module 168 may determine a problem based on a user search query and/or information resource accessed. For example, if a user is accessing an information resource regarding a feature the user does not have enabled, the problem inference module 168 may determine that the user is attempting to access features the user cannot currently access.

As such, the solution module 170 may generate one or more solutions to the problems inferred by the problem inference module 168. Depending on the implementation, the solutions may be one or more historical solutions tried by and/or indicated to work by one or more past users. In further implementations, the solutions may be automatically determined and/or pre-determined solutions to one or more account problems detected. For example, if the inferred problem is that a campaign is not being displayed, and the recommendation module 154 determines that the campaign is not being displayed because one or more content items do not meet predetermined guidelines, the solution module 170 may generate a solution indicating steps to modify the content item to fit the guidelines.

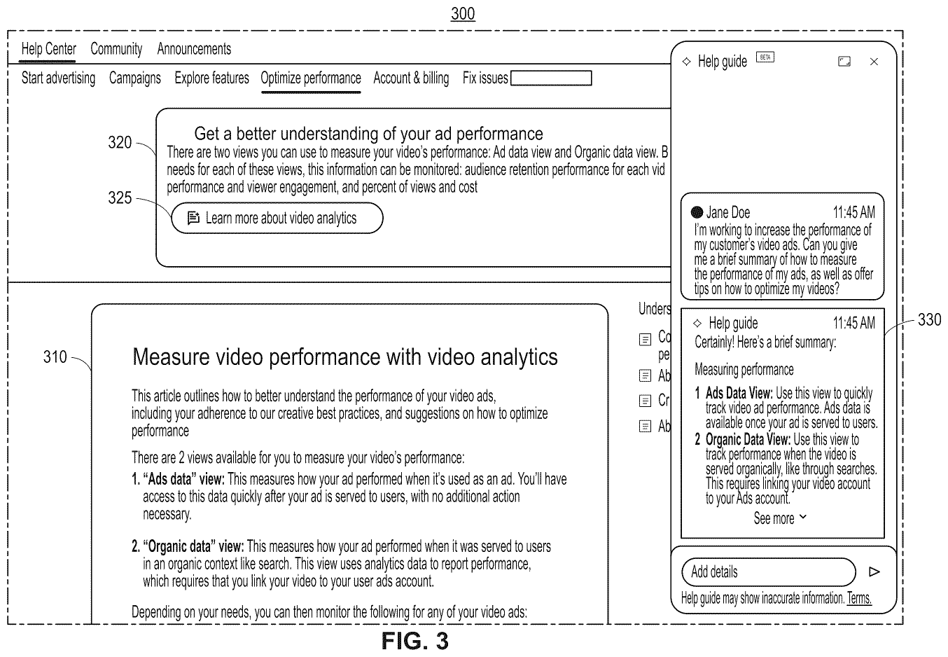

In further implementations, the solution module 170 may generate solutions as a set of instructions, as a link to one or more products and/or pages, as an embedded solution in the window (e.g., as described below for FIGS. 3-5), etc. In some implementations, the solution module 170 works with the search module 106 to link the user to a particular portion of a product and/or content item (referred to herein as a product deeplink). In further implementations, the solution module 170 may access content and/or other information resources (e.g., stored in the content database) to summarize a solution and present such to the user as a recommendation and/or solution. Depending on the implementation, the solution module 170 may be or include an LLM configured to generate such solutions, as described in more detail below.

In some implementations and/or scenarios, the computing system 104 (or another computing system not shown in FIG. 1) trains the models of the personalization module 150, the quality module 152, and/or the recommendation module. In particular, the training module 156 may train the modules using historical data 172 (e.g., from past searches, the search module 106, etc.) and/or quality module data 174 (e.g., as generated by the quality module 152 and/or other modules) as described herein. In some implementations, the historical data 172 is generalized data rather than personalized user data. For example, the training module 156 may use a filtering model to determine that users who broadly search for X while an account has a problem Y to broadly train the models and/or modules on populations rather than individuals.

In some implementations, training module 156 is included in a computing system other than computing system 104, and computing system 104 only includes or accesses the models and/or modules in question after the model(s)/module(s) is/are trained. In some implementations, training machine learning models may produce byproduct weights, or parameters which may be initialized to random values. The training module 156 may modify the weights as the network is iteratively trained, by using one of several gradient descent algorithms, to reduce loss and to cause the values output by the network to converge to expected (or “learned”) values.

In some implementations, as noted above, the modules and/or models may be or include a generative AI model and may have been trained by computing system 104 or another computing system using supervised or semi-supervised learning techniques, using training data of the appropriate modality (e.g., text data). Such generative AI models may be general-purpose models (e.g., trained on a wide array of publicly available datasets such as web pages, documents, etc., available via the Internet) or may be a domain-specific model (e.g., trained or fine-tuned on custom and/or proprietary datasets, such as documents/data available via one or more intranets). In some implementations, the generative AI models have parameters tuned, via the training process.

In some implementations, the computing system 104 accesses a remote server/system that provides generative AI as a service (i.e., with at least a portion of the personalization module 150, the quality module 152, and/or the recommendation module 154 residing at a location remote from the computing system 104). In other implementations, the personalization module 150, the quality module 152, and/or the recommendation module 154 are local to the computing system 104. Thus, the personalization module 150, the quality module 152, and/or the recommendation module 154 may reside at the computing system 104 as shown in FIG. 1, or the computing system 104 may access the personalization module 150, the quality module 152, and/or the recommendation module 154 by communicating with another computing system via the network 110. For example, the personalization module 150, the quality module 152, and/or the recommendation module 154 may be or include AI models that a remote server makes available to computing systems (including computing system 104) via an application programming interface (API).

The historical data 172 and/or quality module data 174 may generally include any text data used for training purposes. The historical data 172 and/or quality module data 174 may include, for example, search data, summary data, and/or historical data for such metrics as described herein.

The operation of the personalization module 150, the quality module 152, the recommendation module 154, the training module 156, and their constituent parts, will be discussed in further detail below in connection with various example implementations.

FIGS. 2A and 2B depict exemplary models that may be used (or parts of which may be used) as part of the personalization module 150, the quality module 152, and/or the recommendation module 154, for example. It is understood, however, that these are just some of a number of suitable AI model types that may be used by the computing system 104.

Turning first to FIG. 2A, an exemplary model 200A uses generative AI techniques. The model 200A may be used as part of the personalization module 150, the quality module 152, and/or the recommendation module 154, for example. In particular, a generator model 210 and a discriminator model 220 receive inputs to generate a binary classification 235 and output a sequence of words and/or other metrics as described herein. In particular, the generator model 210 receives an input vector 205A to generate a generated example 215. In some implementations, the input vector 205A is a fixed-length random vector. In some implementations, the input vector 205A may be drawn randomly from a Gaussian distribution. Depending on the implementation, the vector space corresponding to the input vector 205A may include one or more hidden variables (e.g., variables that are not directly observable). In some implementations, the input vector 205A is used to seed the generative process. Using the input vector 205A, the generator model 210 then generates a generated example 215.

In some implementations, the discriminator model 220 then receives the generated example 215 or a real example 225. The discriminator model 220 may generate a binary classification 235 inferring/indicating whether the received input is model-generated or real. The exemplary model 200A may additionally output an output product and/or use the binary classification 235 in training the generator model 210 and/or discriminator model 220.

In still further implementations, the exemplary model 200A uses both the generator model 210 and the discriminator model 220 for training and subsequently uses only the generator model 210 for generative modeling as described herein.

In some implementations, the generator model 210 and the discriminator model 220 are trained according to adversarial techniques (e.g., when the discriminator model 220 correctly generates the binary classification 235, the generator model 210 is updated and, when the discriminator model 220 incorrectly generates the binary classification 235, the discriminator model 220 is updated).

Depending on the implementation, the generator model 210 and/or the discriminator model 220 may be or include neural networks, such as artificial neural networks (ANN), convolution neural networks (CNN), or recurrent neural networks (RNN). In further implementations, the model 200A, the generator model 210, and/or the discriminator model 220 may incorporate, include, be, and/or otherwise use techniques including and/or in a manner reminiscent to language model techniques (e.g., an LLM, a bag-of-words model, etc.). Similarly, the model 200A, the generator model 210, and/or the discriminator model 220 may incorporate, include, be, and/or otherwise use a transformer architecture to utilize the appropriate language model techniques, as described with regard to FIG. 2B below.

FIG. 2B illustrates an exemplary LLM 200B, which receives an input vector 205B similar to input vector 205A and provides an output 260. The LLM 200B may be used as and/or in the personalization module 150, the quality module 152, and/or the recommendation module 154, for example. In some implementations, the LLM 200B is initially trained to predict a word and/or event in a sequence of words and/or events. For example, the LLM 200B may be given a word sequence that leads up to “Today is a,” and predict a next word, such as “sunny day”, “Saturday”, “holiday”, etc. Similarly, the LLM 200B may be trained to generate an event in a series of events. For example, the LLM 200B may be given a series of events that leads up to a content item being displayed to a user and predicting a user response, such as clicking through the content item to a webpage, ignoring the content item, etc.

In some implementations, transformers are used to train the LLM 200B (e.g., a generative pre-trained transformer (GPT) model). More specifically, some implementations use a GPT model that includes (i) an encoder that processes the input sequence, and (ii) a decoder that generates the output sequence. The encoder and decoder may both include a multi-head self-attention mechanism that allows the GPT model to differentially weight parts of the input sequence to infer meaning and context (e.g., using metadata in the historical and/or training data), for example.

The input vector 205B may be a vector representative of relationships between words, sequences, etc. in the input. The LLM 200B may include a self-attention block 252 component to attend to different parts of the input simultaneously or near-simultaneously to capture relationships and/or dependencies between the different parts of the input (e.g., referred to as a multi self-attention block, multi-head attention block, multi-head self-attention block, masked multi self-attention block, masked multi-head attention block, masked multi-head self-attention block, etc.). In particular, the self-attention block 252 relates different positions of a sequence to compute a representation of the sequence. As such, the self-attention block 252 may weigh an impact of different words in a sequence when sequencing. As such, the LLM 200B learns to give emphasis to different portions of an input vector 205B.

The self-attention block 252 may then compute an attention score representing the impact of each word and/or event in the sentence with respect to the other words and/or events in the sentence (e.g., by taking a dot product between different vector sets). The output then proceeds to the normalization layer 254. The normalization layer 254 may normalize the output of the self-attention block 252 (e.g., by applying a softmax function to normalize the scores).

Similarly, the self-attention block 252 may provide output to a feed-forward network block 256, which performs a non-linear transformation to generate a new representation of the input and/or relationships between words, sequences, etc. In particular, the feed-forward network block 256 may compute a weighted sum of the vectors, using the calculated and normalized attention scores to capture the contextual relationships between words. In some implementations, the normalization layer 254 and/or the self-attention block 252 performs the computation to generate a representation of the relationship between words, etc. After the feed-forward network block 256, an additional normalization layer 258 may normalize the respective output and/or add residual connection(s) to allow the output to move directly to another input. The LLM 200B may therefore learn which parts of an input are important (e.g., remain prevalent through the normalization process). Depending on the implementation, the training of LLM 200B may repeat the process any suitable number of times.

Depending on the implementation, an encoder and/or a decoder may be trained as described above. In further implementations, the encoder is trained in accordance with the above, and a decoder includes an additional self-attention block (not shown) receiving the output of the encoder.

FIG. 3 depicts an example user interface (UI) 300 for generating personalized solution recommendations for an inferred user problem. Depending on the implementation, a computing system (e.g., computing system 104 of FIG. 1) may perform the actions and/or generate the outputs as described herein via a personalization module (e.g., personalization module 150), quality module (e.g., quality module 152), recommendation module (e.g., recommendation module 154), and/or training module (e.g., training module 156) before causing a client device (e.g., client device 102 of FIG. 1) to display the UI 300.

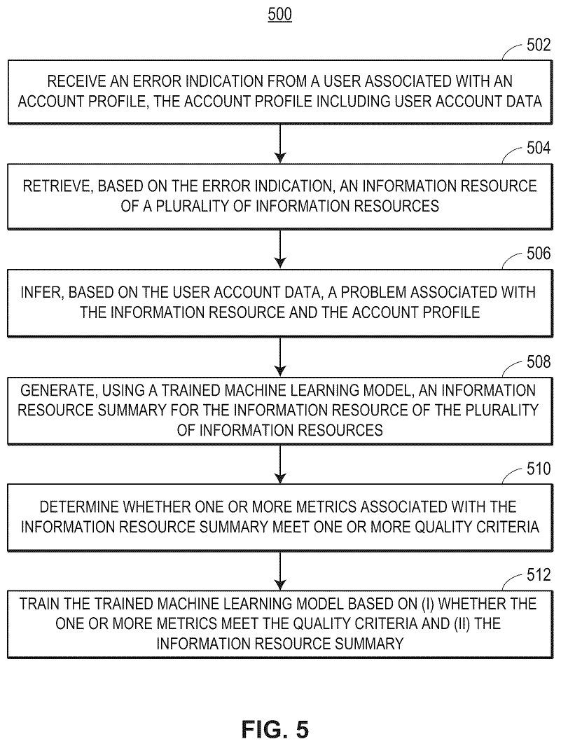

In some implementations, the UI 300 displays an information resource 310 that the user searched for, as described herein with regard to FIGS. 1 and 5. In particular, the information resource 310 may be or include a help page, a document to assist a user, a video tutorial, and/or any other such information resource as described herein. In some implementations, the UI 300 displays the information resource responsive to an indication from the user to view the information resource (e.g., a button press and/or click event, scrolling a mouse wheel, sliding an element displayed via a touch screen, etc.).

In further implementations, the UI 300 displays a generated information resource summary 320 (e.g., as generated by the personalization module 150 as described with regard to FIGS. 1 and 5). The generated information resource summary 320 may be or include a summary of what the computing system 104 determines to be information most relevant to the user and/or key elements of the information resource 310.

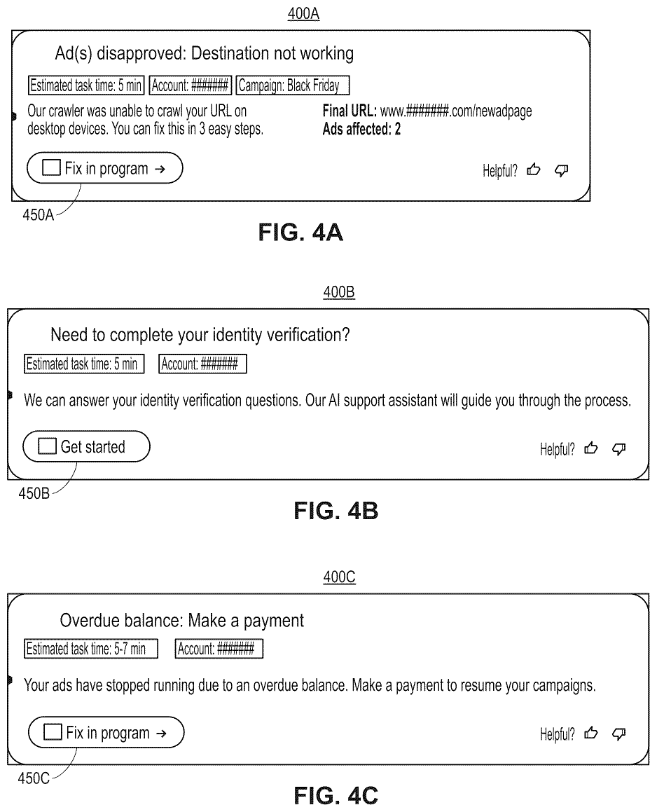

The UI 300 may additionally or alternative display a solution element 325. Depending on the implementation, the solution element 325 may be or include an element that, when interacted with, causes a solution to be automatically applied to the account (e.g., as detailed in more depth below with regard to FIGS. 4A-4C); an element that, when interacted with generates the information resource summary 320; an element that, when interacted with, opens an AI window 330; an element that, when interacted with, automatically moves the user to a predetermined page and/or position (e.g., a product link, a deeplink, embedded API/application, etc.) of the information resource 310, an associated application, a user settings page, etc.

In some implementations, the UI 300 additionally displays an AI window 330 (e.g., responsive to an interaction with the solution element 325). Depending on the implementation, the AI window 330 may function as a chat window with a trained machine learning model. The trained machine learning model may display additional information to supplement the information resource summary 320 (e.g., personalized to the user); recommended solution(s); product links and/or deeplinks, embedded programs, applications, and/or APIs; etc.

FIGS. 4A-4C illustrate exemplary solution summaries 400A, 400B, and/or 400C (collectively referred to as “solution summaries 400”). Depending on the implementation, the solution summaries 400 may be or include the information resource summary 320 of FIG. 3. In further implementations, the solution summaries 400 may be or include a direct solution for the user to implement. In some implementations, the solution summary 400 includes a solution element 450A, 450B, and/or 450C (collectively referred to as “solution elements 450”). Depending on the implementation, the solution elements 450 may be or include the solution element 325 of FIG. 3. Responsive to an interaction event form a user, the solution elements 450 may cause the computing system 104 to navigate to a solution, implement a solution, generate a summary of a solution, initiate a machine learning model (e.g., via the AI window 330 of FIG. 3), and/or otherwise generate and/or provide a proposed solution to an inferred user problem. In further implementations, the solution summaries 400 may include an estimated task time, an account ID, a campaign ID, a summary, an inferred problem description/summary, a related URL, an affected content count, and/or other such elements as described herein.

FIG. 5 is a flow diagram of an example method 500 for generating personalized solution recommendations for an inferred user problem. The method 500 may be implemented using instructions stored on one or more non-transitory, computer-readable media (e.g., memory 144) that are executed by one or more processors in one or more computing devices. For example, the method 500 may be implemented by the processor 142 of the computing system 104 in FIG. 1, when executing instructions of the personalization module 150, the quality module 152, the recommendation module 154, the training module 156, and/or one or more other modules/components. It will be understood that additional, fewer, and/or alternate components may be used to implement the example method 500, and/or that the method 500 may include more or fewer blocks than shown (and/or in a different order than shown).

At block 502, the computing system 104 may receive an error indication from a user associated with an account profile. Depending on the implementation, the error indication may be an explicit search query, an implicit search query (e.g., a search query that the computing system 104 determines is indicative of an error), a link from an error page, an automatically generated error indication (e.g., based on a search query), etc. In some implementations, the account profile includes a user account data. In some implementations, the error indication may be input by the user into a field (e.g., a search bar, a chat box window, etc.) directly. In further implementations, the client device 102 and/or computing system 104 may automatically generate the error indication responsive to an input from the user (e.g., generating a query based on an interaction event by the user with a button, link, content item, etc.). In still further implementations, the client device 102 and/or computing system 104 may analyze an input from the user and generate the error indication based on the input. For example, a user may input part of a query and the client device 102 and/or computing system 104 may predict, propose, and/or otherwise generate an error indication related to the user input. In some implementations, the client device 102 and/or computing system 104 may determine the error indication and or present an information resource to the user based on the user account data.

Depending on the implementation, the user account data may include data associated with a user, one or more products used by the user, one or more products sold by the user, one or more content items uploaded and/or generated by the user, user settings associated with the user, user status (e.g., as described below), a search history associated with the user, an error history associated with the user, and/or any other such data as described herein. In some implementations, the user account data may include and/or be one or more user facts associated with the user. For example, the user facts may be or include a facts regarding a business type for the user, facts regarding an account status of the user, facts regarding a status of one or more content items associated with the user (e.g., whether the content item(s) meet one or more requirements, have been flagged, include video files, etc.).

At block 504, the computing system 104 may retrieve, based on the error indication, an information resource of a plurality of information resources. Depending on the implementation, the information resource may be a document (e.g., hosted on a server), a web page, an image file, a video file, an audio file, etc. As described above, in some implementations, the computing system 104 may retrieve the information resource based at least partially on the user account data. In some such implementations, the computing system 104 may automatically use user account data when the user is logged in, when the user indicates to use such, when the user proactively enables a setting associated with such, etc.

At block 506, the computing system 104 may infer a problem associated with the information resource and the user associated with the account profile. As mentioned previously herein, the inferred problem may be seen as an intermediary input that helps disambiguate the error indication. In some implementations, the computing system 104 determines the inferred problem based at least in part on the user account data associated with the account profile. In some implementations, the computing system 104 determines the inferred problem by determining relevancy scores for a plurality of inferred problems (e.g., including the inferred problem), and determining a most likely problem for the user based on the relevancy scores for the plurality of inferred problems.

In some implementations, the computing system 104 determines the inferred problem and/or the relevancy scores using one or more user signals and facts indicated by and/or included in the user account data. In some such implementations, the user signals and facts may be indicative of an account status (e.g., a membership has expired), one or more user product traits (e.g., a category for which the user uploads content items), statuses of one or more content items (e.g., elements that the user generates, exports, uploads, or otherwise provides to the computing system 104), etc. For example, the computing system 104 may determine that a user has one or more content items that do not meet requirements to be displayed. Then, when a user accesses an information resource related to content display problems (e.g., a help page titled “Why My Content Won't Display”), the computing system 104 may determine that the user is looking for a solution to the problem that content items are not displaying properly. Similarly, the computing system 104 may utilize one or more models (e.g., trained machine learning models) to determine information based on the user account data (e.g., determining that content items are out of date or not relevant, determining that content items are broken or not displaying, determining that guidelines or requirements are broken, etc.). Depending on the implementation, the computing system 104 may further perform one or more actions as described below based on an account status (e.g., a flag indicative of an account status). As described in more detail herein, a user account may, for example, be a basic or premium account, a beta or regular account, have a setting enabled or disabled, etc., and may therefore perform different actions based on such. As such, for example, the computing system 104 may perform at least some of blocks 508, 510, and 512 when the account has a first status (e.g., a basic account status), and may perform other actions (e.g., the automatic solution generation and implementation details described below) when the account has a second status (e.g., a premium account status).

In some implementations, the information resource is treated as a primary driver for intent detection of the user. As such, the computing system 104 may attempt to detect and/or determine relevant and/or important issues associated with the information resource. In further implementations, some user account data may always be given priority and/or displayed to the user. For example, if a user account is suspended and/or no campaigns or content items are present in the account, the computing system 104 may display information associated with such regardless of whether the information resource normally provides information related to such.

At block 508, the computing system 104 may generate an information resource summary for the information resource of the plurality of information resources. In some implementations, the computing system 104 generates the information resource summary using a trained machine learning model. In some such implementations, the computing system 104 inputs the information resource and user account data into the trained machine learning model to generate an output summary based on both the account data and the information resource (e.g., to determine what elements/sections of the information resource are relevant and/or useful to the user). In some implementation, the computing system 104 generates a prompt for the trained machine learning model based on the information resource and/or the user account data. In such implementations, the computing system 104 may then input the prompt into the trained machine learning model to generate the output summary. Depending on the implementation, the trained machine learning model may be a generative artificial intelligence (AI) model (e.g., Google Gemini), such as the transformer model described with regard to FIGS. 2A and 2B. In some implementations, the trained machine learning model may be fine-tuned to support analysis, detection of problems, and/or generation of solutions related to particular content items.

In some such implementations, the trained machine learning model is a first trained machine learning model, and the information resource summary includes a link to a second trained machine learning model. Depending on the implementation, the computing system 104 may detect an interaction event with the link and, responsive to detecting the interaction event, the computing system 104 may automatically input at least the inferred problem and the information resource summary into the second trained machine learning model. The computing system 104 may then generate, using the second trained machine learning model, a recommended solution response to the inferred problem. In some implementations, the recommended solution may include one or more descriptions of what the inferred problem is and why the solution will solve the inferred problem.

Depending on the implementation, the recommended solution response to the inferred problem may include a product link that, when interacted with by the user, automatically implements at least part of the recommended solution response. For example, the product link may be a link to open a particular application, activate a particular product, initiate software, etc. Depending on the implementation, the product link may be or include a deeplink to a particular portion of a product associated with the product link. For example, a deeplink may be a link not only to initiate an application, but also to direct the user to a particular part of the application (e.g., a particular menu, application page, form, etc.).

In some implementations, the computing system 104 obtains and/or analyzes metadata for product links, user account data, and/or information resources. In some such implementations, the metadata for product links may include particular application settings and/or pages opened (e.g., where a deeplink leads), average time users spend on a linked time, average clicks after clicking on a link within a predetermined period (e.g., additional pages navigated to), and/or any other such metadata as described herein. In some such implementations, the computing system 104 determines where user facts and metadata for the product links match and/or are related, and may present the product links and/or deeplinks accordingly. In some implementations, the product links and/or deeplinks may be associated with particular user facts and, if the user facts are present in the user account data, the computing system 104 may present the product links regardless of whether the information resource would normally be associated with such. In still further implementations, the computing system 104 may determine that a particular product is associated and may link to and/or display a repository of product deeplinks for the particular product. By determining and presenting the most accurate deeplink, the computing system 104 may reduce the number of links followed, greatly reducing network resource usage, latency, and time spent navigating through an application or other such resource.

In some implementations, rather than providing product deeplinks to the user, another model and/or module of the computing system 104 may determine and generate a series of steps and/or links for the trained machine learning model to take. As such, the computing system 104 may automatically perform an action as if the action is performed by an API embedded in the model and/or application. As such, one or more actions (e.g., determined solutions as described below (such as verifying payment via code within the application and callable by the trained machine learning model)) may be embedded into the application.

In some implementations, the computing system 104 uses one or more additional models to analyze user account data and determine what elements of the information resource are useful, relevant, important, or any other such metric for including in the information resource summary. In some such implementations, the computing system 104 analyzes the user account data to determine one or more categories of information the user may be interested in. In further implementations, the computing system 104 determines a relevancy score for different sections of the information resource and/or the user account data, and determines what to include in the information resource summary based on the relevancy score(s). Depending on the implementation, the relevancy score may be based on and/or generated offline (e.g., in the virtual testing environment described herein) by a system curating relevancy of facts in an information resource to one or more predicted and/or historical scenarios. As such, the computing system 104 may remove minutia that is irrelevant to particular questions and/or queries, generating a more accurate information resource summary more quickly and using fewer resources.

At block 510, the computing system 104 may determine whether one or more parameters associated with the information resource summary meet a one or more quality criteria (e.g., a minimum quality bar). Depending on the implementation, the one or more parameters may include at least one of: (i) actuality, (ii) presence of particular generated components (iii) topic relevance, (iv) information resource relation, (v) user behavior expectations, (vi) presence of solution, and/or (vii) any other such metric as described herein. Depending on the implementation, the quality criteria may be a different quality criterion for each parameter of the one or more parameters. In some implementations, the quality criteria may be predetermined, adjustable, manually set, automatically generated, etc.

In some implementations, the computing system 104 automatically grades each parameter according to a rubric (e.g., 1-5, 1-10, 0-100, etc.). Depending on the implementation, the computing system 104 may initially train the machine learning model using manually labeled datasets graded according to the rubric. In further implementations, the computing system 104 trains the machine learning model using datasets automatically generated by another machine learning model according to the rubric. In some such implementations, the machine learning model(s) evaluate each parameter using a separately generated set of prompts to determine an output score for each respective parameter. As such, the machine learning model(s) may produce scores both in aggregate (e.g., for all parameters) and/or for individual parameters. Depending on the implementation, the computing system 104 may have and/or receive the quality criteria for the summary in aggregate and/or for each individual parameter. If the score(s) are below the quality criteria, then the computing system 104 may train the machine learning model(s) as described in more detail below. By training the machine learning model(s) as described herein and based on the quality criteria, the instant techniques may improve the ability of the machine learning models to detect and/or mitigate hallucinations. Similarly, by using the inferred problem as an intermediary input, the instant techniques may better disambiguate the error indication, and may therefore further improve hallucination mitigation as described in more detail above.

At block 512, the computing system 104 may train a machine learning model (e.g., the machine learning model utilized at block 508) based on the generated information resource summary. In some implementations, the computing system 104 may additionally or alternatively train the machine learning model based on whether the one or more parameters meet the quality criteria.

In some implementations, the computing system 104 may implement and/or otherwise operate in an online environment and an offline environment. As such, the computing system 104 may provide information and/or respond to a user in real-time and/or near real-time (e.g., responsive to user requests, inputs, prompts, etc.). Additionally, the computing system 104 may utilize data in an offline environment for training, modifying, adding, and/or otherwise modifying parameters, machine learning models, inputs, etc. As such, in some implementations, the computing system 104 may display or cause display of the information resource summary to the user in real-time (e.g., in the online environment). In further implementations, the computing system 104 may additionally or alternatively display or cause display of the information resource summary in the offline environment.

Depending on the implementation, the computing system 104 may utilize the offline environment (also referred to herein as a “virtual testing environment” or “offline virtual testing environment”) for training the machine learning model. For example, the computing system 104 may implement blocks 510 and/or 512 in the offline virtual testing environment. As such, determining whether the one or more parameters meet the quality criteria and training the machine learning model may occur in the offline virtual testing environment. Therefore, the computing system 104 may iteratively evaluate changes to see how the model(s) change the output without impacting what a user sees. In further implementations, the computing system 104 may change the user account data in the offline environment to generate outputs to see how different users would change the output, and subsequently determine whether changes to the model would lead to a drop in performance for other user(s) and/or user types. Depending on the implementation, the variations on the user account data and/or prompts may be automatically generated based on predicted scenarios and/or based on historical data. In further implementations, the computing system 104 may implement additional blocks and/or other processes in the offline virtual testing environment as described herein.

In some implementations, at least some of the blocks of FIG. 5 (e.g., blocks 508, 510, 512, etc.) are performed based on an account status. As such, in some implementations, the computing system 104 determines whether a status of the account profile includes a first status indicator or a second status indicator. Depending on the implementation, the first status indicator may indicate that the account is a basic account (e.g., an account without further access to additional features) and the second status indicator may indicate that the account is a premium account (e.g., an account with further access to the additional features), or vice versa. In further alternate implementations, the first status indicator may be a default option and the second status indicator may be selected by the user (e.g., by enabling functionality in a user account settings menu). In still further alternate implementations, the first status indicator and the second status indicator may be based on a country and/or language associated with the user account, and the availability of functionality according to such (e.g., according to available languages, regional policies, limited size feature rollouts, etc.). Depending on the implementation, the account profile may initially include the first status indicator upon account creation and may change to include the second status indicator responsive to action by the user associated with the account profile (e.g., payment to upgrade to a premium account, agreement to participate in a beta test, input of a code, interaction with an account setting, etc.).

In some implementations, at least some of (i) the generating of the information resource summary (e.g., at block 508), the determining of whether the one or more parameters meet the quality criteria (e.g., at block 510), and (iii) the training of the trained machine learning model occur when (e.g., after, responsive to, while, etc.) the computing system 104 determines that the status of the account profile includes the first status indicator. In further implementations, when the computing system 104 determines that the status of the account profile includes the second status indicator, the computing system 104 may perform additional alternate operations. In some such implementations, the computing system 104 may generate a proposed solution response to the inferred problem and, responsive to receiving an indication from the user, implementing the proposed solution response to the inferred problem. For example, the computing system 104 may determine that a user content item is not being properly displayed due to an image size (e.g., at block 506), and may generate a solution response. The computing system 104 may, for example, determine that user-indicated cropping would address the problem, and the computing system 104 may therefore generate the solution and a button that the user can interact with to begin the proposed solution.

Artificial intelligence (AI) is a segment of computer science that focuses on the creation of models that can perform tasks with little to no human intervention. Artificial intelligence systems can utilize, for example, machine learning and computer vision. Machine learning, and its subsets, such as deep learning, focus on developing models that can infer outputs from data. The outputs can include, for example, predictions and/or classifications. Computer vision focuses on analyzing and interpreting images and videos. Artificial intelligence systems can include generative models that generate new content in response to input prompts and/or based on other information.

Example machine-learned models include neural networks or other multi-layer non-linear models. Example neural networks include feed forward neural networks, deep neural networks, recurrent neural networks, and convolutional neural networks. Some example machine-learned models can leverage an attention mechanism such as self-attention. For example, some machine-learned models can include multi-headed self-attention models (e.g., transformer models).

The model(s) can be trained using various training or learning techniques. The training can implement supervised learning, unsupervised learning, reinforcement learning, etc. The training can use techniques such as, for example, backwards propagation of errors. For example, a loss function can be backpropagated through the model(s) to update one or more parameters of the model(s) (e.g., based on a gradient of the loss function). Various loss functions can be used such as mean squared error, likelihood loss, cross entropy loss, hinge loss, and/or various other loss functions. Gradient descent techniques can be used to iteratively update the parameters over a number of training iterations. A number of generalization techniques (e.g., weight decays, dropouts) can be used to improve the generalization capability of the models being trained.

The model(s) can be pre-trained before domain-specific alignment. For instance, a model can be pretrained over a general corpus of training data and fine-tuned on a more targeted corpus of training data. A model can be aligned using prompts that are designed to elicit domain-specific outputs. Prompts can be designed to include learned prompt values (e.g., soft prompts). The trained model(s) may be validated prior to their use using input data other than the training data and may be further updated or refined during their use based on additional feedback/inputs.

In some implementations, the computing system 104 may use one or more of the machine learning models noted above to perform any one or more of the operations discussed herein in connection with machine learning (e.g., for use as machine learning model 162).

The following list of examples reflects a variety of the embodiments explicitly contemplated by the present disclosure:

Example 1. A computer-implemented method for generating personalized solution recommendations for a user problem, the computer-implemented method comprising: receiving, by one or more processors, an error indication from a user associated with an account profile, the account profile including user account data; retrieving, by the one or more processors and based on the error indication, an information resource of a plurality of information resources; inferring, by the one or more processors and based on the user account data, a problem associated with the information resource and the account profile; generating, by the one or more processors and using a trained machine learning model, an information resource summary for the information resource of the plurality of information resources by using the information resource and the inferred problem as inputs to the trained machine learning model; determining, by the one or more processors, whether one or more metrics associated with the information resource summary meet one or more quality criteria; and training, by the one or more processors, the trained machine learning model based on (i) whether the one or more metrics meet the one or more quality criteria and (ii) the information resource summary.

Example 2. The computer-implemented method of example 1, further comprising: displaying, by the one or more processors, the information resource summary to the user in an online real-time environment.

Example 3. The computer-implemented method of example 2, wherein (i) the determining whether the one or more metrics meet the one or more quality criteria and (ii) the training occur in an offline virtual testing environment.

Example 4. The computer-implemented method of example 1, wherein inferring the problem includes: determining, by the one or more processors, relevancy scores for a plurality of inferred problems, the plurality of inferred problems including the inferred problem; and determining, by the one or more processors, a most likely problem for the user based on the relevancy scores for the plurality of inferred problems.

Example 5. The computer-implemented method of example 1, further comprising: determining, by the one or more processors, whether a status of the account profile includes a first status indicator or a second status indicator; wherein (i) the generating of the information resource summary, (ii) the determining of whether the one or more metrics meet the one or more quality criteria, and (iii) the training of the trained machine learning model occur responsive to determining that the status of the account profile includes the first status indicator.

Example 6. The computer-implemented method of example 5, further comprising: responsive to determining that the status of the account profile includes the second status indicator: generating, by the one or more processors, a proposed solution response to the inferred problem, and responsive to receiving an indication from the user, implementing the proposed solution response to the inferred problem.

Example 7. The computer-implemented method of example 1, wherein the trained machine learning model is a first trained machine learning model and the information resource summary includes an element that, when interacted with, initiates a second trained machine learning model, the method further comprising: detecting, by the one or more processors, an interaction event with the element; responsive to the detecting, automatically inputting at least the inferred problem and the information resource summary into the second trained machine learning model; and generating, by the one or more processors and using the second trained machine learning model, a recommended solution response to the inferred problem.

Example 8. The computer-implemented method of example 7, wherein the recommended solution response to the inferred problem includes a product link that, when interacted with by the user, automatically implements at least part of the recommended solution response.

Example 9. The computer-implemented method of example 8, wherein the product link includes a deeplink to a particular portion of a product associated with the product link.

Example 10. The computer-implemented method of example 1, wherein the one or more metrics include at least one of: (i) actuality, (ii) presence of particular generated components (iii) topic relevance, (iv) information resource relation, (v) user behavior expectations, or (vi) presence of solution.

Example 11. A computing system configured to generate personalized solution recommendations for a user problem, the computing system comprising: one or more processors; and a memory storing instructions that, when executed, cause the one or more processors to: receive an error indication from a user associated with an account profile, the account profile including user account data; retrieve, based on the error indication, an information resource of a plurality of information resources; inferring, based on the user account data, a problem associated with the information resource and the account profile; generate, using a trained machine learning model, an information resource summary for the information resource of the plurality of information resources by using the information resource and the inferred problem as inputs to the trained machine learning model; determine whether one or more metrics associated with the information resource summary meet one or more quality criteria; and train the trained machine learning model based on (i) whether the one or more metrics meet the one or more quality criteria and (ii) the information resource summary.

Example 12. The computing system of example 11, wherein the memory stores further instructions that, when executed, cause the one or more processors to: display the information resource summary to the user in an online real-time environment.

Example 13. The computing system of example 12, wherein (i) determining whether the one or more metrics meet the one or more quality criteria and (ii) training the trained machine learning model occur in an offline virtual testing environment.

Example 14. The computing system of example 11, wherein inferring the problem includes: determining relevancy scores for a plurality of inferred problems, the plurality of inferred problems including the inferred problem; and determining a most likely problem for the user based on the relevancy scores for the plurality of inferred problems.

Example 15. The computing system of example 11, wherein the memory stores further instructions that, when executed, cause the one or more processors to: determine whether a status of the account profile includes a first status indicator or a second status indicator; wherein (i) generating the information resource summary, (ii) determining whether the one or more metrics meet the one or more quality criteria, and (iii) training the trained machine learning model occur responsive to determining that the status of the account profile includes the first status indicator.

Example 16. The computing system of example 15, wherein the memory stores further instructions that, when executed, cause the one or more processors to: responsive to determining that the status of the account profile includes the second status indicator: generate a proposed solution response to the inferred problem, and responsive to receiving an indication from the user, implement the proposed solution response to the inferred problem.

Example 17. The computing system of example 11, wherein the trained machine learning model is a first trained machine learning model, the information resource summary includes an element that, when interacted with, initiates a second trained machine learning model, and the memory stores further instructions that, when executed, cause the one or more processors to: detect an interaction event with the element; responsive to detecting the interaction event, automatically input at least the inferred problem and the information resource summary into the second trained machine learning model; and generate, using the second trained machine learning model, a recommended solution response to the inferred problem.

Example 18. The computing system of example 17, wherein the recommended solution response to the inferred problem includes a product link that, when interacted with by the user, automatically implements at least part of the recommended solution response.

Example 19. The computing system of example 18, wherein the product link includes a deeplink to a particular portion of a product associated with the product link.

Example 20. The computing system of example 11, wherein the one or more metrics include at least one of: (i) actuality, (ii) presence of particular generated components (iii) topic relevance, (iv) information resource relation, (v) user behavior expectations, or (vi) presence of solution.

Although the foregoing text sets forth a detailed description of numerous different aspects and implementations of the invention, it should be understood that the scope of the patent is defined by the words of the claims set forth at the end of this patent. The detailed description is to be construed as exemplary only.

The following additional considerations apply to the foregoing discussion. Throughout this specification, plural instances may implement components, operations, or structures described as a single instance. Although individual operations of one or more methods are illustrated and described as separate operations, one or more of the individual operations may be performed concurrently, and nothing requires that the operations be performed in the order illustrated. Structures and functionality presented as separate components in example configurations may be implemented as a combined structure or component. Similarly, structures and functionality presented as a single component may be implemented as separate components. These and other variations, modifications, additions, and improvements fall within the scope of the subject matter of the present disclosure.

Unless specifically stated otherwise, discussions in the present disclosure using words such as “processing,” “computing,” “calculating,” “determining,” “presenting,” “displaying,” or the like may refer to actions or processes of a machine (e.g., a computer) that manipulates or transforms data represented as physical (e.g., electronic, magnetic, or optical) quantities within one or more memories (e.g., volatile memory, non-volatile memory, or a combination thereof), registers, or other machine components that receive, store, transmit, or display information.

As used in the present disclosure any reference to “one implementation” or “an implementation” means that a particular element, feature, structure, or characteristic described in connection with the implementation is included in at least one implementation or implementation. The appearances of the phrase “in one implementation” in various places in the specification are not necessarily all referring to the same implementation.

As used in the present disclosure, the terms “comprises,” “comprising,” “includes,” “including,” “has,” “having” or any other variation thereof, are intended to cover a non-exclusive inclusion. For example, a process, method, article, or apparatus that comprises a list of elements is not necessarily limited to only those elements but may include other elements not expressly listed or inherent to such process, method, article, or apparatus. Further, unless expressly stated to the contrary, “or” refers to an inclusive or and not to an exclusive or. For example, a condition A or B is satisfied by any one of the following: A is true (or present), and B is false (or not present), A is false (or not present) and B is true (or present), and both A and B are true (or present).

Unless otherwise apparent from the context of use, reference in the present disclosure to a same set of “one or more processors” (or a same “plurality of processors,” etc.) performing multiple operations can encompass implementations in which performance of the operations is divided among the processor(s) in any suitable way. For example, “generating, by one or more processors, X; and generating, by the one or more processors, Y” can encompass: (1) implementations in which a first subset of the processors (e.g., in a first computing device) generates X and an entirely distinct, second subset of the processors (e.g., in a different, second computing device) independently generates Y; (2) implementations in which one or more or all of the processor(s) (e.g., one or multiple processors in the same device, or multiple processors distributed among multiple devices) contribute to the generation of X and/or Y; and (3) other variations.

Upon reading this disclosure, those of skill in the art will appreciate still additional alternative structural and functional designs through the principles described herein. Thus, while particular implementations and applications have been illustrated and described, it is to be understood that the disclosed implementations are not limited to the precise construction and components disclosed in the present disclosure. Various modifications, changes, and variations, which will be apparent to those skilled in the art, may be made in the arrangement, operation and details of the method and apparatus disclosed in the present disclosure without departing from the spirit and scope defined in the appended claims.

What is claimed is:

1. A computer-implemented method for generating personalized solution recommendations for a user problem, the computer-implemented method comprising:
receiving, by one or more processors, an error indication from a user associated with an account profile, the account profile including user account data;
retrieving, by the one or more processors and based on the error indication, an information resource of a plurality of information resources;
inferring, by the one or more processors and based on the user account data, a problem associated with the information resource and the account profile;
generating, by the one or more processors and using a trained machine learning model, an information resource summary for the information resource of the plurality of information resources by using the information resource and the inferred problem as inputs to the trained machine learning model;
determining, by the one or more processors, whether one or more metrics associated with the information resource summary meet one or more quality criteria; and
training, by the one or more processors, the trained machine learning model based on (i) whether the one or more metrics meet the one or more quality criteria and (ii) the information resource summary.

2. The computer-implemented method of claim 1, further comprising:
displaying, by the one or more processors, the information resource summary to the user in an online real-time environment.

3. The computer-implemented method of claim 2, wherein (i) the determining whether the one or more metrics meet the one or more quality criteria and (ii) the training occur in an offline virtual testing environment.

4. The computer-implemented method of claim 1, wherein inferring the problem includes:
determining, by the one or more processors, relevancy scores for a plurality of inferred problems, the plurality of inferred problems including the inferred problem; and
determining, by the one or more processors, a most likely problem for the user based on the relevancy scores for the plurality of inferred problems.

5. The computer-implemented method of claim 1, further comprising:
determining, by the one or more processors, whether a status of the account profile includes a first status indicator or a second status indicator;
wherein (i) the generating of the information resource summary, (ii) the determining of whether the one or more metrics meet the one or more quality criteria, and (iii) the training of the trained machine learning model occur responsive to determining that the status of the account profile includes the first status indicator.

6. The computer-implemented method of claim 5, further comprising:
responsive to determining that the status of the account profile includes the second status indicator:
generating, by the one or more processors, a proposed solution response to the inferred problem, and
responsive to receiving an indication from the user, implementing the proposed solution response to the inferred problem.

7. The computer-implemented method of claim 1, wherein the trained machine learning model is a first trained machine learning model and the information resource summary includes an element that, when interacted with, initiates a second trained machine learning model, the method further comprising:
detecting, by the one or more processors, an interaction event with the element;
responsive to the detecting, automatically inputting at least the inferred problem and the information resource summary into the second trained machine learning model; and
generating, by the one or more processors and using the second trained machine learning model, a recommended solution response to the inferred problem.

8. The computer-implemented method of claim 7, wherein the recommended solution response to the inferred problem includes a product link that, when interacted with by the user, automatically implements at least part of the recommended solution response.

9. The computer-implemented method of claim 8, wherein the product link includes a deeplink to a particular portion of a product associated with the product link.

10. The computer-implemented method of claim 1, wherein the one or more metrics include at least one of: (i) actuality, (ii) presence of particular generated components (iii) topic relevance, (iv) information resource relation, (v) user behavior expectations, or (vi) presence of solution.

11. A computing system configured to generate personalized solution recommendations for a user problem, the computing system comprising:
one or more processors; and
a memory storing instructions that, when executed, cause the one or more processors to:
receive an error indication from a user associated with an account profile, the account profile including user account data;
retrieve, based on the error indication, an information resource of a plurality of information resources;
inferring, based on the user account data, a problem associated with the information resource and the account profile;
generate, using a trained machine learning model, an information resource summary for the information resource of the plurality of information resources by using the information resource and the inferred problem as inputs to the trained machine learning model;
determine whether one or more metrics associated with the information resource summary meet one or more quality criteria; and
train the trained machine learning model based on (i) whether the one or more metrics meet the one or more quality criteria and (ii) the information resource summary.

12. The computing system of claim 11, wherein the memory stores further instructions that, when executed, cause the one or more processors to:
display the information resource summary to the user in an online real-time environment.

13. The computing system of claim 12, wherein (i) determining whether the one or more metrics meet the one or more quality criteria and (ii) training the trained machine learning model occur in an offline virtual testing environment.

14. The computing system of claim 11, wherein inferring the problem includes:
determining relevancy scores for a plurality of inferred problems, the plurality of inferred problems including the inferred problem; and
determining a most likely problem for the user based on the relevancy scores for the plurality of inferred problems.

15. The computing system of claim 11, wherein the memory stores further instructions that, when executed, cause the one or more processors to:
determine whether a status of the account profile includes a first status indicator or a second status indicator;
wherein (i) generating the information resource summary, (ii) determining whether the one or more metrics meet the one or more quality criteria, and (iii) training the trained machine learning model occur responsive to determining that the status of the account profile includes the first status indicator.

16. The computing system of claim 15, wherein the memory stores further instructions that, when executed, cause the one or more processors to:
responsive to determining that the status of the account profile includes the second status indicator:
generate a proposed solution response to the inferred problem, and
responsive to receiving an indication from the user, implement the proposed solution response to the inferred problem.

17. The computing system of claim 11, wherein the trained machine learning model is a first trained machine learning model, the information resource summary includes an element that, when interacted with, initiates a second trained machine learning model, and the memory stores further instructions that, when executed, cause the one or more processors to:
detect an interaction event with the element;
responsive to detecting the interaction event, automatically input at least the inferred problem and the information resource summary into the second trained machine learning model; and
generate, using the second trained machine learning model, a recommended solution response to the inferred problem.

18. The computing system of claim 17, wherein the recommended solution response to the inferred problem includes a product link that, when interacted with by the user, automatically implements at least part of the recommended solution response.

19. The computing system of claim 18, wherein the product link includes a deeplink to a particular portion of a product associated with the product link.

20. The computing system of claim 11, wherein the one or more metrics include at least one of: (i) actuality, (ii) presence of particular generated components (iii) topic relevance, (iv) information resource relation, (v) user behavior expectations, or (vi) presence of solution.
